(19) United States
(12) Patent Application Publication
(10) Pub. No.: US 2017/0191466 A1
(43) Pub. Date: Jul. 6, 2017

(54) ELECTROSTATIC CONVERTER

(71) Applicants: COMMISSARIAT À L'ENERGIE ATOMIQUE ET AUX ENERGIES ALTERNATIVES, Paris (FR); UNIVERSITÉ GRENOBLE ALPES, Saint-Martin-D'Heres (FR)

(72) Inventors: Matthias PEREZ, Grenoble (FR); Sébastien BOISSEAU, Echirolles (FR); Jean-Luc REBOUD, Grenoble (FR)

(73) Assignees: COMMISSARIAT À L'ENERGIE ATOMIQUE ET AUX ENERGIES ALTERNATIVES, Paris (FR); UNIVERSITÉ GRENOBLE ALPES, Saint-Martin-D'Heres (FR)

(21) Appl. No.: 15/399,889

(22) Filed: Jan. 6, 2017

(30) Foreign Application Priority Data
Jan. 6, 2016 (FR) 1650075

(51) Int. Cl. F03D 9/25; F03D 1/06; H02N 1/04

(52) U.S. Cl. CPC F03D 9/25; H02N 1/04; F03D 1/0633

(57) ABSTRACT

This electrostatic converter comprises a rotor comprising at least one blade designed to receive an air flow; a stator comprising at least one electrode; a flexible membrane fitted on the blade, and comprising a counter-electrode, the electrode or the counter-electrode being coated with a dielectric material suitable to be polarized; the flexible membrane describing a trajectory when the rotor performs a rotation; the flexible membrane being configured to come into sliding contact with the stator on a first part of the trajectory, and configured to be at a distance from the stator on a second part of the trajectory so as to form a variable electric capacitance variable suitable to induce an electric current.

### BACKGROUND OF THE INVENTION

The present invention relates to an electrostatic converter of turbine type. For example purposes, applications in hybrid energy recovery/flowmeter operation are envisaged in particular in the automobile, aeronautic and habitat fields.

### STATE OF THE ART

An electrostatic converter known in the state of the art, in particular from the document DE 20 2012 009 612, comprises:
a rotor comprising at least one blade designed to receive an air flow;
a stator comprising at least one electrode.

One end of the blade comprises a counter-electrode coated with a dielectric material suitable to be polarized. Such an electrostatic converter is of the wind turbine type and forms an energy recovery unit. The kinetic power of the air flow is converted into electricity. First of all, the turbine converts the air flow into a relative rotation movement between the stator and the rotor. The relative rotation movement then induces electric capacitance variations between the electrode or electrodes of the stator and the counter-electrode of the or each blade.

The distance separating an electrode of the stator and a counter-electrode of the rotor is a critical parameter of the electrostatic converter in so far as it has an effect on the variation of the electric capacitance and on the conversion power. The smaller this distance, the greater the possibility of extracting electric power.

Such an electrostatic converter of the prior art is not completely satisfactory in that industrial geometric checking of this separating distance is complex, particularly when the separating distance is smaller than 500 μm, on account of the relative rotation movement between the stator and rotor. Impacts between the rotor and stator are then liable to occur and to cause large energy losses, or even trip the turbine. Perfectly controlled industrial geometric checking of this separating distance would involve prohibitive manufacturing costs (micro-fabrications, roll-free ball bearings, etc.).

### SUMMARY OF THE INVENTION

The aim of the present invention is therefore to either totally or partially remedy the above-mentioned shortcomings, and relates for this purpose to an electrostatic converter comprising:
a rotor comprising at least one blade designed to receive an air flow;
a stator comprising at least one electrode coated with a dielectric material suitable to be polarized;
a flexible membrane fitted on the blade and comprising a counter-electrode; the flexible membrane describing a trajectory when the rotor performs a rotation; the flexible membrane being configured so that the counter-electrode comes into sliding contact with the dielectric material on a first part of the trajectory, and so that the counter-electrode is located at a distance from the dielectric material on a second part of the trajectory so as to obtain a variable electric capacitance suitable to induce an electric current.

Such an electrostatic converter according to the invention thereby means that an industrial geometric check of the distance between an electrode of the stator and a counter-electrode of the rotor can be circumvented by means of such a flexible membrane. The flexible membrane enables large electric capacitance variations to be obtained for a very low friction relatively to an impact between the rotor and stator of the state of the art. The risks of impact between the blade and stator are eliminated, including in the case of turbulent flow, as the flexible membrane is fitted between the blade and the stator, forming a separator. Furthermore, manufacturing of such an electrostatic converter is simple and inexpensive.

What is meant by “sliding contact” is that the counter-electrode of the flexible membrane moves in a direction parallel to the contact surface with the dielectric material (on the electrode of the stator) on the first part of the trajectory.

The invention also relates to an electrostatic converter comprising:
a rotor comprising at least one blade designed to receive an air flow;
a stator comprising at least one electrode;
a flexible membrane fitted on the blade and comprising a counter-electrode coated with a dielectric material suitable to be polarized; the flexible membrane describing a trajectory when the rotor performs a rotation; the flexible membrane being configured so that the dielectric material comes into sliding contact with the electrode on the first part of the trajectory, and so that the dielectric material is located at a distance from the electrode on a second part of the trajectory so as to obtain a variable electric capacitance suitable to induce an electric current.

Such an electrostatic converter according to the invention thus means that an industrial geometric check of the distance between an electrode of the stator and a counter-electrode of the rotor can be circumvented by the use of such a flexible membrane. The flexible membrane enables large electric capacitance variations to be obtained for a very low friction relatively to an impact between the rotor and stator of the state of the art. The risks of impact between the blade and stator are eliminated, including in the case of turbulent flow, as the flexible membrane is fitted between the blade and the stator, forming a separator. Furthermore, manufacturing of such an electrostatic converter is simple and inexpensive.

What is meant by “sliding contact” is that the dielectric material (on the counter-electrode) moves in a direction parallel to the contact surface with the dielectric material on the first part of the trajectory.

The common inventive concept between the two electrostatic converters according to the invention is the sliding contact between the flexible membrane and the stator, which enables energy losses relatively to intermittent impacts to be reduced.

Advantageously, the flexible membrane is at least partially ferromagnetic, and the stator comprises magnetizing means arranged to keep the flexible membrane in sliding contact with the stator on the first part of the trajectory.

Such magnetizing means thereby make it possible to overcome fluttering problems of the flexible membrane which are liable to occur in particular when the stiffness of the membrane is too low or when the speed of rotation of the rotor is too high. These oscillations can interrupt the contact between the flexible membrane and the stator on the first part of the trajectory.

According to a variant, the electrostatic converter comprises ballast means arranged to keep the flexible membrane in sliding contact with the stator on the first part of the trajectory.

Such ballast means thus make it possible to overcome fluttering problems of the flexible membrane which are liable to occur in particular when the stiffness of the membrane is too low or when the speed of rotation of the rotor is too high. These oscillations can interrupt the contact between the flexible membrane and the stator on the first part of the trajectory.

Advantageously, the flexible membrane presents a flexural stiffness comprised between 1 mN/m and 10 N/m.

Such a flexural stiffness is thus sufficiently strong to prevent oscillations from occurring and sufficiently weak to avoid large frictions with the stator. The flexural stiffness is preferably about 1 N/m.

Advantageously, the electrode presents a length, noted L₀, and the flexible membrane presents a length, noted L, verifying L₀≦L≦5L₀.

Such a membrane length L thus enables the electrode to be completely coated.

According to one embodiment, the dielectric material is an electret.

Such a dielectric material thus possesses a quasi-permanent polarization state and obviates the necessity for providing an electric power supply dedicated to polarization.

According to one form of execution, the electret is selected from the group comprising a polytetrafluoroethylene (PTFE) such as Teflon®, a tetrafluoroethylene and hexafluoropropylene copolymer (FEP), a SiO₂—Si₃N₄ stack, and an amorphous perfluorinated polymer such as Cytop®.

Advantageously, the flexible membrane and the stator are of suitable nature to exchange electrostatic charges by triboelectric effect on the first part of the trajectory via the dielectric material.

The dielectric material can thus be polarized if it is not an electret or can be recharged if it is an electret.

If it is not an electret, the dielectric material is advantageously selected from the group comprising polyvinylidene fluoride (PVDF), a polyimide such as Kapton®, polymethyl methacrylate (PMMA) and nylon.

Advantageously, the rotor presents an axis of rotation, the blade presents a distal end relatively to the axis of rotation, and the flexible membrane is fitted on the distal end of the blade.

Advantageously, the stator comprises a set of electrodes preferably arranged uniformly around the trajectory.

The stator thus forms or part of a sump protecting the blade or blades of the rotor. The trajectory of the flexible membrane being essentially circular, the stator advantageously presents the shape of a cylinder, a disc or a sphere.

Advantageously, the set of electrodes comprises Nₑ successive electrodes arranged around the trajectory, Nₑ being a natural integer greater than or equal to 3; and the counter-electrode of the flexible membrane forms a network of patterns arranged in such a way that, on the first part of the trajectory, two consecutive patterns are:

in contact with a k-th electrode and a (k+2)-th electrode, and

at a distance from a (k+1)-th electrode, with k ∈ [symbol] 1,Nₑ [symbol] .

Such a network of patterns thus forms a texturing of the counter-electrode and of the flexible membrane. Such a textured counter-electrode enables:

the frequency of variation of the electric capacitance to be increased without increasing the number of flexible membranes,

the design of the flexible membrane to be simplified, for example to avoid simultaneous covering of two adjacent electrodes by the flexible membrane.

Advantageously, the rotor comprises Nₚ blades, Nₚ being an integer greater than or equal to 1, the flexible membrane being fitted on each blade, and the stator comprises a set of Nₑ electrodes, Nₑ being an integer verifying Nₑ=2Nₚ.

Such a distribution is thereby optimized in order to have a maximum ratio Nₑ×(Cₘₐₓ−Cₘᵢₙ), where Cₘₐₓ and Cₘᵢₙ are respectively the maximum and minimum electric capacitance obtained on a rotation of the rotor.

Advantageously, the flexible membrane comprises a film of a material presenting a Young's modulus comprised between 100 MPa and 5 GPa, preferably comprised between 1 GPa and 5 GPa.

Advantageously, the film presents a thickness comprised between 1 μm and 1 mm, preferably comprised between 1 μm and 125 μm, more preferentially comprised between 1 μm and 50 μm.

Advantageously, the dielectric material presents a thickness comprised between 1 μm and 125 μm, preferably comprised between 25 μm and 100 μm.

Advantageously, the stator comprises an electric circuit in which the induced current flows, the electric circuit being connected to said at least one electrode.

In this way, connection of the electric circuit only to the electrodes of the stator (Slot-effect connection) and not both to the electrodes of the stator and to the counter-electrodes of the rotor (Cross-wafer connection), is easier to implement.

### BRIEF DESCRIPTION OF THE DRAWINGS

Other features and advantages will become clearly apparent from the following description of different embodiments of the invention, given for non-restrictive example purposes only, with reference to the appended drawings in which:

FIG. 1 is a schematic perspective view of an electrostatic converter according to an embodiment of the invention,

FIGS. 2a to 2e are partial schematic side views illustrating different positions of the flexible membrane,

FIG. 3 is a partial schematic view, in cross-section, of an electrostatic converter according to an embodiment of the invention,

FIG. 4 is a partial schematic view, in cross-section, of an electrostatic converter according to an embodiment of the invention,

FIGS. 5 to 7 are schematic perspective views of an electrostatic converter according to different embodiments of the invention,

FIG. 8 is a partial schematic side view of an electrostatic converter according to an embodiment of the invention.

### DETAILED DESCRIPTION OF THE EMBODIMENTS

For the different embodiments, the same reference numerals will be used for parts that are identical or which perform the same function, for the sake of simplification of the description. The technical characteristics described in the following for different embodiments are to be considered either alone or in any technically possible combination.

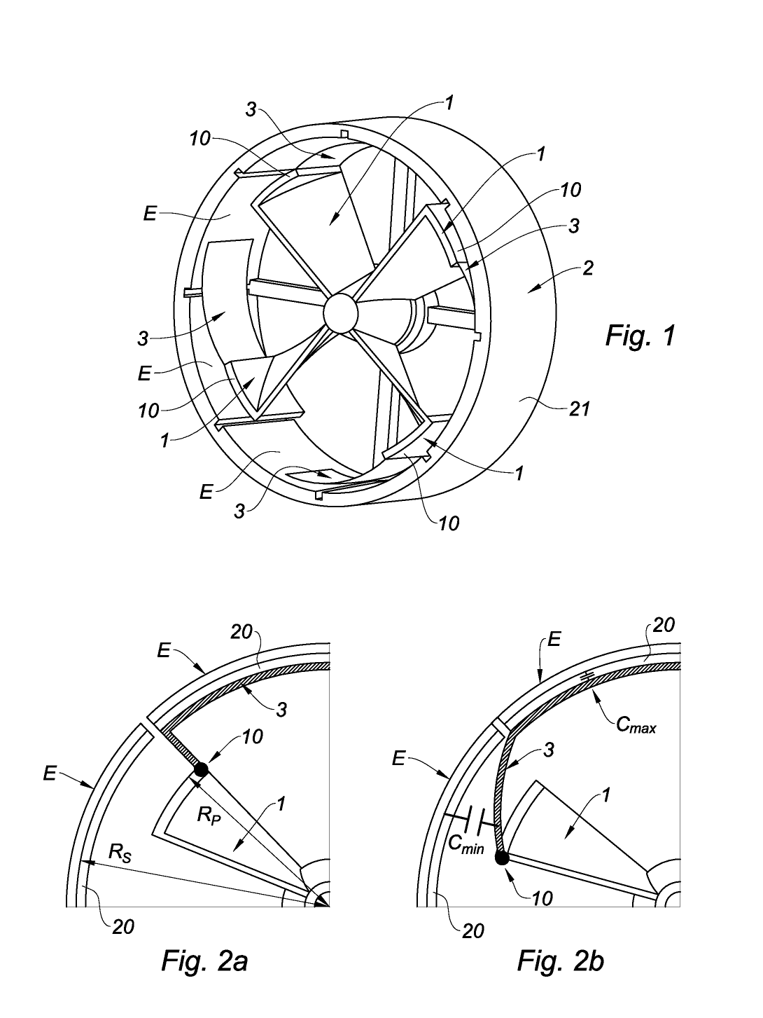

The electrostatic converter illustrated in FIG. 1 is an electrostatic converter comprising:
a rotor comprising at least one blade 1 designed to receive an air flow;
a stator 2 comprising at least one electrode E;
a flexible membrane 3 fitted on the blade 1 and comprising a counter-electrode; the flexible membrane 3 describing a trajectory when the rotor performs a rotation.

According to a first embodiment, the electrode E is coated with a dielectric material 20 suitable to be polarized. The flexible membrane 3 is configured so that the counter-electrode comes into sliding contact with the dielectric material 20 on a first part of the trajectory, and so that the counter-electrode is located at a distance from the dielectric material 20 on a second part of the trajectory so as to obtain a variable electric capacitance suitable to induce an electric current.

According to a second embodiment, the counter-electrode is coated with a dielectric material 20 suitable to be polarized. The flexible membrane 3 is configured so that the dielectric material 20 comes into sliding contact with the electrode E on a first part of the trajectory, and so that the dielectric material 20 is located at a distance from the electrode E on a second part of the trajectory so as to obtain a variable electric capacitance suitable to induce an electric current.

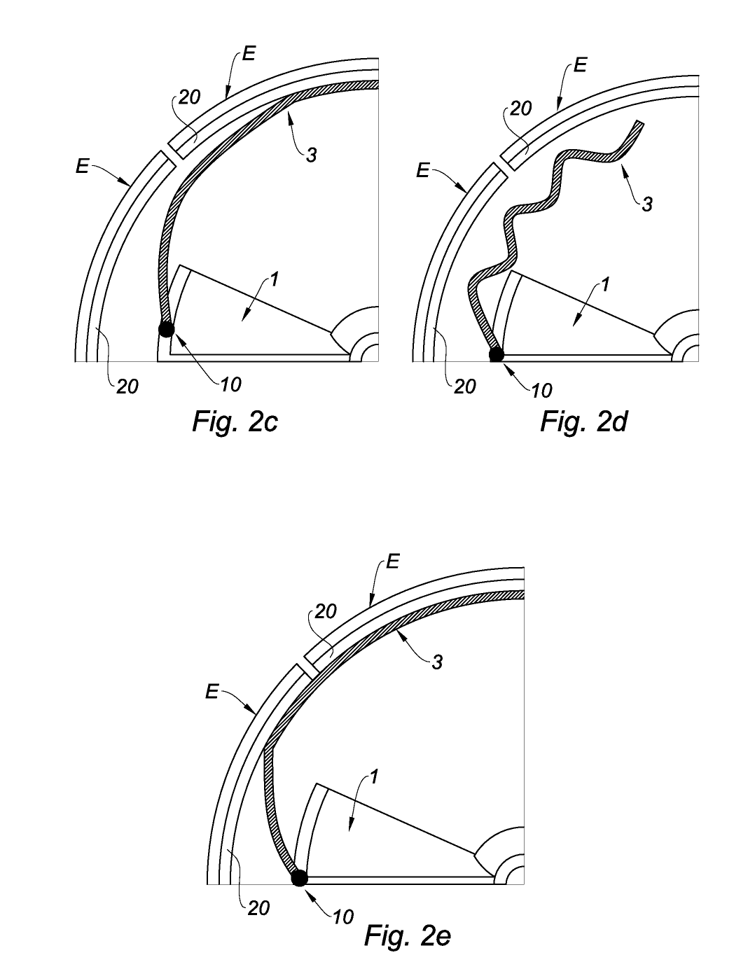

More precisely, the rotor illustrated in FIG. 1 comprises four blades 1. The rotor presents an axis of rotation that is preferably horizontal and parallel to the air flow. Each blade 1 presents a distal end 10 relatively to the axis of rotation, and the flexible membrane 3 is fitted on the distal end of each blade 1. The distal end 10 is situated at a distance Rₚ from the centre of rotation of the rotor (visible in FIG. 2). The air flow advantageously presents a speed greater than or equal to 2 m/s.

More precisely, the stator 2 illustrated in FIG. 1 comprises a set of Nₑ electrodes E, Nₑ being an integer verifying Nₑ=2×Nₚ, where Nₚ, is the number of blades, i.e. Nₑ=8. Such a distribution is optimized in order to have a maximum ratio Nₑ×(Cₘₐₓ−Cₘᵢₙ) where Cₘₐₓ and Cₘᵢₙ are respectively the maximum and minimum electric capacitance obtained when the rotor performs a rotation, as illustrated in FIG. 2b. The set of Nₑ electrodes E is distributed uniformly around the trajectory of the flexible membrane 3 the trajectory being circular and determined by the rotor. In the first embodiment, the Nₑ electrodes E are coated with the dielectric material 20. Each electrode E advantageously presents the same length, noted L₀ in the sense of arc length and of curvilinear abscissa. The first part of the trajectory of the flexible membrane, forming an arc of a circle, 3 corresponds to the curved contact surface between the flexible membrane 3 and the corresponding electrode E. The stator 2 forms a cylindrical sump 21 designed to protect the blades 1 of the rotor. The electrodes E of the stator are located at a distance Rₛ from the centre of rotation of the rotor (visible in FIG. 2). The distance separating an electrode E of the stator 2 and a counter-electrode of the rotor corresponds to the difference between Rₛ and Rₚ, i.e. Rₛ−Rₚ. The stator 2 advantageously comprises an electric circuit (not shown) in which the induced current flows, the electric circuit being connected to each electrode E.

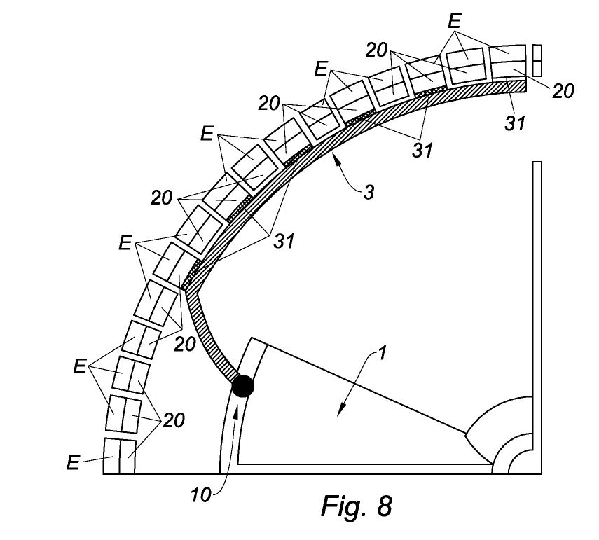

According to an embodiment illustrated in FIG. 8, the set of electrodes E comprises Nₑ successive electrodes E arranged around the trajectory of the flexible membrane 3, Nₑ being a natural integer greater than or equal to 3. The counter-electrode of the flexible membrane 3 forms a network of patterns 31 arranged so that, on the first part of the trajectory of the flexible membrane 3 two consecutive patterns 31 are:

in contact with a k-th electrode E and a (k+2)-th electrode E, and

at a distance from a (k+1)-th electrode E, with k∈ [symbol] 1,Nₑ [symbol] .

In the first embodiment, the Nₑ electrodes E are coated with the dielectric material 20, as illustrated in FIG. 8. In the second embodiment, the patterns 31 of the network are coated with the dielectric material 20. If the Nₑ successive electrodes E are arranged around the trajectory of the flexible membrane 3 with a period p, the network of patterns 31 then advantageously presents a period 31 p/2. The network of patterns 31 is advantageously made from a metallic material forming a metallic texturing of the counter-electrode.

The dielectric material 20 is advantageously an electret. The electret is advantageously selected from the group comprising a polytetrafluoroethylene (PTFE) such as Teflon®, a tetrafluoroethylene and hexafluoropropylene copolymer (FEP), a SiO₂—Si₃N₄ stack, and an amorphous perfluorinated polymer such Cytop®. The polarization voltage at the terminal of the electret is such that the power of the electrostatic converter is about one μW/cm². For example purposes, the electric breakdown field of a PTFE is about 60 kV/cm and the electric polarization field is about 20 V/μm.

The flexible membrane 3 and stator 2 are advantageously suitable to exchange electrostatic charges by triboelectric effect on the first part of the trajectory via the dielectric material 20. When the dielectric material 20 is not an electret, the polarization voltage at the terminals of the dielectric material 20 is such that the power of the electrostatic converter is about one nW/cm². The dielectric material 20 is then advantageously selected from the group comprising polyvinylidene fluoride (PVDF), a polyimide such as Kapton®, polymethyl methacrylate (PMMA) and nylon. The dielectric material 20 advantageously presents a thickness comprised between 1μm and 125 μm, preferably comprised between 25 μm and 100 μm.

The flexible membrane 3 advantageously presents a flexural stiffness comprised between 1 mN/m and 10 N/m. The flexible membrane 3 can be simulated as a fixed-free beam. The flexural stiffness is then expressed by the formula

$$k = \frac{3 EI}{{L}^{3}} = \frac{{EHe}_{f}^{3}}{4 {L}^{3}} , \qquad$$

l being the quadratic moment, L being the length of the beam comprised between 1 mm and 10 cm, E being the modulus of elasticity of the beam comprised between 100 MPa and 5 GPa, e_{f} being the thickness of the beam comprised between 1 μm and 1 mm, and H being the width of the beam comprised between 1 mm and 10 cm. The flexible membrane 3 is advantageously a flexible blade. What is meant by “blade” is a thin strip of elongate shape. The flexible membrane 3 advantageously presents a length, noted L, verifying L₀≦L≦5L₀. The flexible membrane 3 advantageously presents a film made from a material presenting a Young's modulus comprised between 100 MPa and 5 GPa, preferably comprised between 1 GPa and 5 GPa. The film advantageously presents a thickness comprised between 1 μm and 1 mm, preferably comprised between 1 μm and 125 μm, more preferentially comprised between 1 μm and 50 μm. The flexible membrane 3 advantageously presents an electrically conducting part, preferably metallic, forming the counter-electrode. In the first embodiment, the counter-electrode comes into sliding contact with the dielectric material 20 on the first part of the trajectory. The electrically conducting part is made from a material preferentially selected from the group comprising copper, gold, silver, aluminium, iron, platinum, and graphite. The flexible membrane 3 presents a first surface which comes into sliding contact with the dielectric material 20 on the first part of the trajectory for the first embodiment, and a second surface opposite the first surface.

The flexible membrane 3 is subjected to the following forces which determine its position:

the electrostatic force, fixed by the polarization voltage at the terminals of the dielectric material 20, which tends to attract the flexible membrane 3 to the stator 2;

the centrifugal force, proportional to the speed of rotation of the rotor, which also tends to attract the flexible membrane 3 to the stator 2;

the aerodynamic forces (lift and drag), which oppose the movement of the flexible membrane 3 in air, and which tend to move the flexible membrane 3 away from the stator 2;

the elastic return force of the flexible membrane 3.

In addition, the assembly area of the flexible membrane 3 at the distal end 10 of each blade 1. the flexural stiffness of the flexible membrane 3 and the separating distance (Rₛ−Rₚ) are chosen such as:

to cover an electrode E while preventing simultaneous overlapping of two adjacent electrodes E by the flexible membrane 3 as illustrated in FIG. 2e,

to maximize the difference between Cₘₐₓ and Cₘᵢₙ, as illustrated in FIGS. 2a (theoretical case) and 2b (practical case), and prevent the case illustrated in FIG. 2c where Cₘₐₓ is too low,

prevent oscillations of the flexible membrane 3 at a distance from the dielectric material 20 on the first part of the trajectory, as illustrated in FIG. 2d for the first embodiment.

In particular, the oscillations of the flexible membrane 3 are amplified with the speed of rotation of the rotor and a too low stiffness of the membrane. The oscillations are thus amplified with the length of the membrane, a small thickness of the membrane, and the flexibility of the membrane, in accordance with the simulation of a fixed-free beam. The oscillations of the flexible membrane 3 can therefore be reduced by reducing its length, by increasing its thickness or by using a more rigid material.

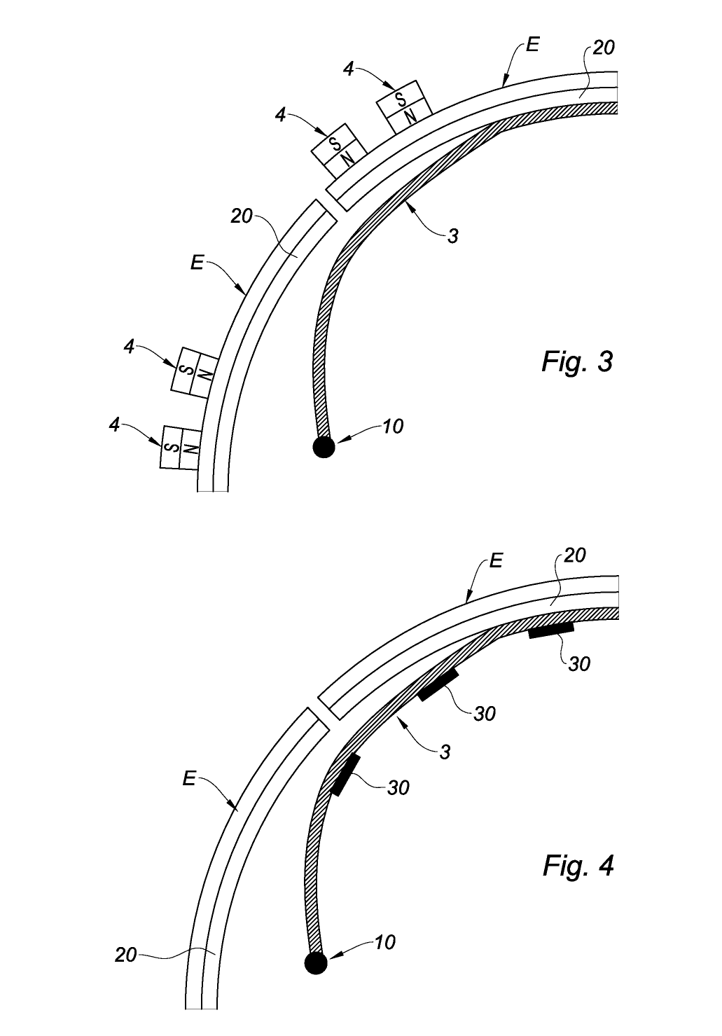

According to an embodiment illustrated in FIG. 3, the flexible membrane 3 is at least partially ferromagnetic, and the stator 2 comprises magnetization means arranged to keep the flexible membrane 3 in sliding contact with the dielectric material 20 of the stator 2 on the first part of the trajectory for the first embodiment. To do this, the counter-electrode of the flexible membrane 3 is advantageously ferromagnetic. As a non-restrictive example, the magnetization means comprise permanent magnets 4 the North and South magnetic poles of which are respectively noted N and S. In the second embodiment, the magnetization means are arranged to keep the dielectric material 20 of the counter-electrode in sliding contact with each electrode E of the stator 2.

According to an alternative embodiment, the electrostatic converter comprises ballast means arranged on the second surface of the flexible membrane 3 to keep the flexible membrane 3 in sliding contact with the dielectric material 20 on the first part of the trajectory for the first embodiment. As a non-restrictive example, the ballast means comprise a plurality of weights 30 fixed to the flexible membrane 3. In the second embodiment, the ballast means arranged on the second surface of the flexible membrane 3 to keep the dielectric material 20 of the counter-electrode in sliding contact with each electrode E of the stator 2.

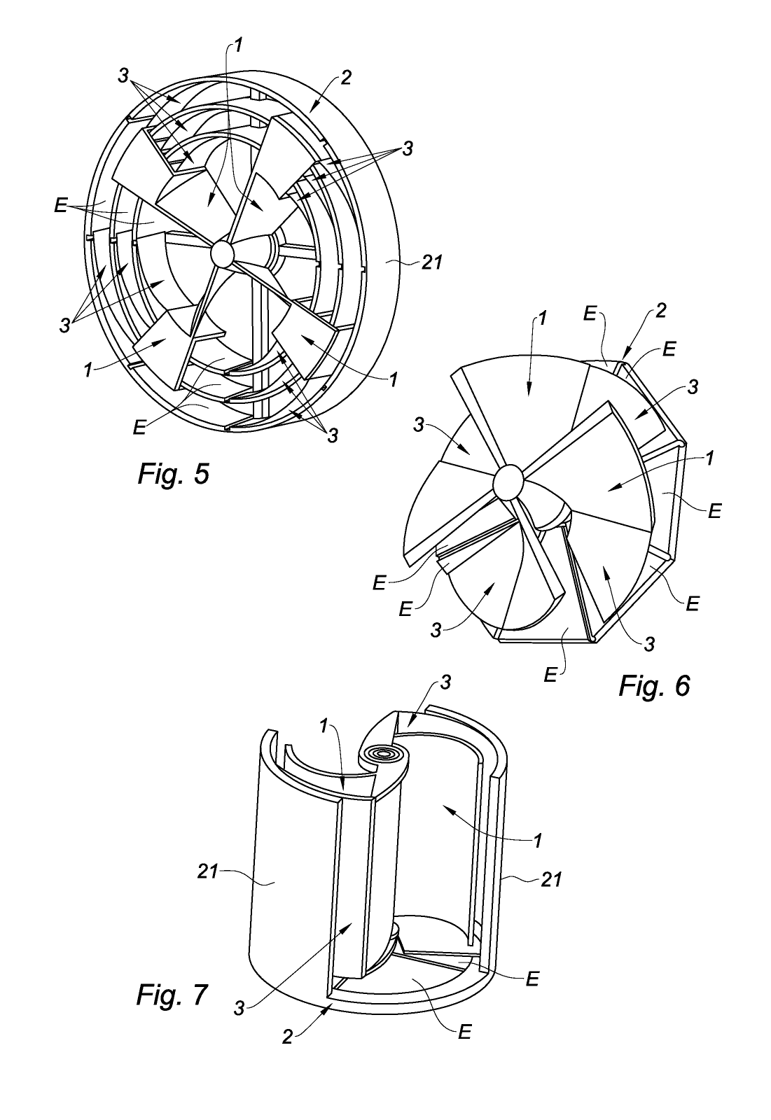

The electrostatic converter illustrated in FIG. 5 differs from the electrostatic converter illustrated in FIG. 1 in particular in that each blade 1 comprises three parallel supports on each of which a flexible membrane 3 is fitted. The sump 21 of the stator 2 comprises three parallel cylindrical elements, each facing a support.

The electrostatic converter illustrated in FIG. 6 differs from the electrostatic converter illustrated in FIG. 1 in particular in that the stator 2 presents the form of a disc.

The electrostatic converter illustrated in FIG. 7 differs from the electrostatic converter illustrated in FIG. 1 in particular in that:

the axis of rotation is vertical,

the sump 21 of the stator 2 comprises two walls facing one another and joined to one another by at least one disc.

1. Electrostatic converter comprising:
a rotor comprising at least one blade designed to receive an air flow;
a stator comprising at least one electrode coated with a dielectric material suitable to be polarized;
a flexible membrane fitted on the blade, and comprising a counter-electrode; the flexible membrane describing a trajectory when the rotor performs a rotation; the flexible membrane being configured so that the counter-electrode comes into sliding contact with the dielectric material on a first part of the trajectory, and so that the counter-electrode is situated at a distance from the dielectric material on a second part of the trajectory so as to obtain a variable electric capacitance suitable to induce an electric current.

2. Electrostatic converter according to claim 1, wherein the flexible membrane is at least partially ferromagnetic, and wherein the stator comprises magnetization means arranged to keep the flexible membrane in sliding contact with the stator on the first part of the trajectory.

3. Electrostatic converter according to claim 1, comprising ballast means arranged to keep the flexible membrane in sliding contact with the stator on the first part of the trajectory.

4. Electrostatic converter according to claim 1, wherein the flexible membrane presents a flexural stiffness comprised between 1 mN/m and 10 N/m.

5. Electrostatic converter according to claim 1, wherein the electrode presents a length, noted L₀, and in that the flexible membrane presents a length, noted L, verifying L₀≦L≦5L₀.

6. Electrostatic converter according to claim 1, wherein the dielectric material is an electret.

7. Electrostatic converter according to claim 1, wherein the flexible membrane and the stator are suitable to exchange electrostatic charges by triboelectric effect on the first part of the trajectory via the dielectric material.

8. Electrostatic converter according to claim 1, wherein the rotor presents an axis of rotation, in that the blade presents a distal end relatively to the axis of rotation, and in that the flexible membrane is fitted on the distal end of the blade.

9. Electrostatic converter according to claim 1, wherein the stator comprises a set of electrodes arranged preferably uniformly around the trajectory.

10. Converter according to claim 9, wherein the set of electrodes comprises Nₑ successive electrodes arranged around the trajectory, Nₑ being a natural integer greater than or equal to 3; and in that the counter-electrode of the flexible membrane forms a network of patterns arranged so that, on the first part of the trajectory, two consecutive patterns are:
in contact with a k-th electrode and a (k+2)-th electrode, and
at a distance from a (k+1)-th electrode, with k∈ [symbol] 1,Nₑ [symbol] .

11. Electrostatic converter according to claim 1, wherein the rotor comprises Nₚ blades, Nₚ being an integer greater than or equal to 1, the flexible membrane being fitted on each blade, and wherein the stator comprises a set of Nₑ electrodes, Nₑ being an integer verifying Nₑ=2Nₚ.

12. Electrostatic converter according to claim 1, wherein the flexible membrane comprises a film made from the material presenting a Young's modulus comprised between 100 MPa and 5 GPa, preferably comprised between 1 GPa and 5 GPa.

13. Electrostatic converter according to claim 13, wherein the film presents a thickness comprised between 1 μm and 1 mm, preferably comprised between 1 μm and 125 μm, more preferentially comprised between 1 μm and 50 μm.

14. Electrostatic converter according to claim 1, wherein the dielectric material presents a thickness comprised between 1 μm and 125 μm, preferably comprised between 25 μm and 100 μm.

15. Electrostatic converter according to claim 1, wherein the stator comprises an electric circuit in which the induced current flows, the electric circuit being connected to said at least one electrode.

16. Electrostatic converter comprising:
a rotor comprising at least one blade designed to receive an air flow;
a stator comprising at least one electrode;
a flexible membrane fitted on the blade, and comprising a counter-electrode coated with a dielectric material suitable to be polarized; the flexible membrane describing a trajectory when the rotor performs a rotation; the flexible membrane being configured so that the counter-electrode comes into sliding contact with the electrode on a first part of the trajectory, and so that the dielectric material is situated at a distance from the electrode on a second part of the trajectory so as to obtain a variable electric capacitance suitable to induce an electric current.

17. Electrostatic converter according to claim 16, wherein the flexible membrane is at least partially ferromagnetic, and wherein the stator comprises magnetization means arranged to keep the flexible membrane in sliding contact with the stator on the first part of the trajectory.

18. Electrostatic converter according to claim 16, comprising ballast means arranged to keep the flexible membrane in sliding contact with the stator on the first part of the trajectory.

19. Electrostatic converter according to claim 16, wherein the flexible membrane presents a flexural stiffness comprised between 1 mN/m and 10 N/m.

20. Electrostatic converter according to claim 16, wherein the electrode presents a length, noted L₀, and in that the flexible membrane presents a length, noted L, verifying L₀≦L≦5L₀.

21. Electrostatic converter according to claim 16, wherein the dielectric material is an electret.

22. Electrostatic converter according to claim 16, wherein the flexible membrane and the stator are suitable to exchange electrostatic charges by triboelectric effect on the first part of the trajectory via the dielectric material.

23. Electrostatic converter according to claim 16, wherein the rotor presents an axis of rotation, in that the blade presents a distal end relatively to the axis of rotation, and wherein the flexible membrane is fitted on the distal end of the blade.

24. Electrostatic converter according to claim 16, wherein the stator comprises a set of electrodes arranged preferably uniformly around the trajectory.

25. Converter according to claim 24, wherein the set of electrodes comprises Nₑ successive electrodes arranged around the trajectory, Nₑ being a natural integer greater than or equal to 3; and in that the counter-electrode of the flexible membrane forms a network of patterns arranged so that, on the first part of the trajectory, two consecutive patterns are:
in contact with a k-th electrode and a (k+2)-th electrode, and
at a distance from a (k+1)-th electrode (E), with k∈ [symbol] 1,Nₑ [symbol] .

26. Electrostatic converter according to claim 16, wherein the rotor comprises Nₚ blades, Nₚ being an integer greater than or equal to 1, the flexible membrane being fitted on each blade, and in that the stator comprises a set of Nₑ electrodes, Nₑ being an integer verifying Nₑ=2Nₚ.

27. Electrostatic converter according to claim 16, wherein the flexible membrane comprises a film made from the material presenting a Young's modulus comprised between 100 MPa and 5 GPa, preferably comprised between 1 GPa and 5 GPa.

28. Electrostatic converter according to claim 16, wherein the film presents a thickness comprised between 1 μm and 1 mm, preferably comprised between 1 μm and 125 μm, more preferentially comprised between 1 μm and 50 μm.

29. Electrostatic converter according to claim 16, wherein the dielectric material presents a thickness comprised between 1 μm and 125 μm, preferably comprised between 25 μm and 100 μm.

30. Electrostatic converter according to claim 16, wherein the stator comprises an electric circuit in which the induced current flows, the electric circuit being connected to said at least one electrode.
